(19) United States
(12) Patent Application Publication
(10) Pub. No.: US 2009/0199317 A1
(43) Pub. Date: Aug. 13, 2009

(54) Hard hat involving wireless data transmission

(75) Inventors: Stefan Schwiers, Monchengladbach (DE); Karl-Heinz Feierle, Dornbirn (AT)

Correspondence Address: BAKER & DANIELS LLP;111 E. WAYNE STREET, SUITE 800, FORT WAYNE, IN, 46802, US

(73) Assignee: IDENTEC SOLUTIONS AG, Lustenau (AT)

(21) Appl. No.: 12/028,036

(22) Filed: Feb. 8, 2008

(51) Int. Cl. A42B 3/00; H04Q 7/00

(52) U.S. Cl. 2/5; 2/425; 340/539.1

(57) ABSTRACT

The invention concerns a hard hat having wireless protection to monitor human measuring values, such as, temperature, pulse, moisture and other values which are recorded in the head section of a human and transmitted wirelessly to a stationary or mobile reception unit and which monitor the physical constitution of the hard hat user.

The invention is characterized by a device at which a hard hat is equipped with a transponder which, in turn, is data connected with several measuring sensors arranged in and at the hard hat. The transponder is also connected with an antenna located in the upper part of the hard hat. This antenna is able to transmit as omnidirectional wave the transmitting frequency transmitted by the transponder in a specific frequency range to a stationary or mobile transceiver located outside of the field.

In addition, the invention is characterized by a procedure to have wireless protection to monitor human measuring values.

The invention concerns a hard hat involving wireless data transmission and a procedure to transmit the data from a hard hat to a stationary or mobile data reception unit.

The invention refers to hard hats of the usual kind, in particular hard hats that are used for sports, but also hard hats used in police and firefighter operations or other operations, miners, construction workers and the like.

It involves the requirement to transmit human values, such as temperature, pulse, moisture and other values that can be collected from the head, wirelessly to a stationary or mobile reception unit in order to monitor the physical constitution of the hard hat user.

For instance, during the American Football league, it was observed that, in 2006, a total of 160 players died as a result of heat shock in the course of the game.

Also firefighter operations require wireless monitoring of the physical constitution of the firefighter in order to avoid that he becomes incapable of action and loses consciousness in the fire or in other dangerous areas.

Previously it was only known to use so-called communication hard hats which have a built-in reception device for wireless voice radio connection so that the player can receive signals during the game from his coach standing outside of the field.

However, the above-mentioned hard hats are not suitable to guarantee that the physical constitution of the hard hat user is monitored. In particular, the above-mentioned hard hats are not suitable to guarantee wireless and relatively uninterrupted monitoring of the physical constitution.

It is therefore the objective of the invention to design a hard hat and a respective transmission procedure for data collection at and in the hard hat so that all data collection in the hard hat is transmitted wirelessly and practically uninterrupted to a stationary or mobile reception unit in radio range of the hard hat.

The technical information included in claim 1 shows how the invention solves the problem.

A significant characteristic of the invention at hand is the fact that each hard hat is equipped with a transponder which, in turn, is connected with several measuring sensors arranged in and at the hard hat. The transponder is also connected with an antenna located in the upper part of the hard hat. This antenna is able to transmit as radio waves the transmitting frequency transmitted by the transponder in a specific frequency range to a stationary or mobile transceiver located outside of the field.

The provided technical information provided involves the significant advantage that wireless data connection is established between a transponder located in the upper part of the hard hat and a retrieving unit located outside of the application area.

For the first time, this results in the possibility to collect human measuring values which then can be transmitted to the retrieving unit via wireless data connection.

Furthermore, it is intended that the transmitting frequency is not transmitted as omnidirectional wave (spherical wave transmitting in circumferential direction) but, instead, as radiated beam, which transmits, for example, via a 120° angle forward and backward.

Transmission as spherical wave, at which the antenna is located in the upper area of the hard hat (preferably at the crown of the head), has the advantage that reception in the reception unit is guaranteed to be always consistent, independent of the inclination of the hard hat and its direction in relationship to the reception unit. The radio waves transmitted from the upper part of the hard hat are not blocked or disrupted by obstacles. As a result, they are transmitted to the reception unit in radio range always with consistent strength. Each hard hat user is its own “radio tower,” as it were, from which a spherical wave is transmitted into all directions.

Instead of transmitting a spherical wave, an alternative embodiment provides for the use of antennas having radiated beam characteristics. By means of the antennas it is possible to determine the direction in which the hard hat user is moving. Such hard hats are used, for example, at oil platforms because the people wearing hard hats there are moving only in channels, permitting to ascertain only one particular direction, either forward or backward. The same applies to underground mines which also have narrow channels in which it is required to determine the direction of the people wearing the hard hat.

In such narrow channels it is necessary to generate an omnidirectional wave. Generating a wave having directivity has the significant advantage that it is necessary to assemble only a small and compact antenna to the hard hat. The antenna can be attached to the outside of the hard hat, on top of the hard hat, for example, by applying a conductible coat, or in the interior of the hard hat, provided it allows electromagnetic waves to penetrate.

Such a radiated beam antenna transmits, for example, in a radio range of 60 degrees forward and 60 degrees backward. The use of another radiated beam characteristic also permits a transmission of 60 degrees forward and 60 degrees backward.

Consequently, this involves the advantage that the size of the attached antenna can be reduced even more if it is decided not to use an omnidirectional transmission antenna in the hard hat at the hard hat or on the hard hat. In this context, the term “omnidirectional” refers to an antenna emitting at a 360 degree angle.

In this regard, it is especially preferred if the transponder is designed as an RFID [radio frequency identification] unit and covers a range of up to 500 m. Preferably, it transmits in different frequency bands, for example, in the UHF frequency band or microwave band, for example, at a frequency of 2.4 GHz.

With regard to this transmitting frequency it is especially important that the hard hat generates omnidirectional wave transmission from all directions of the hard hat and in all situations, independent of the shape of the hard hat. In particular, the shape of the hard hat itself should not disrupt wave transmission.

Therefore, it is preferred in a preferred embodiment of the invention at hand that the antenna is located in the upper part of the hard hat, because from the upper part of the hard hat, (omnidirectional or directional) waves can be transmitted to the distant retrieving unit without being blocked or disrupted.

In order to simplify the explanations, the following description assumes that such a hard hat is designed to be used for sports and that several players on the field are equipped with such hard hats.

However, the invention is not restricted to this use because, as explained at the beginning, it refers also to firefighter hard hats, construction worker hard hats and the like, so that the following examples for use should be considered as exemplifications. Based on a game situation it is important that, in the case of physically extremely active games, it has to be guaranteed that the human values of the respective player are monitored to such an extent that he does not collapse, become unconscious or even experience a cardiac arrest.

The invention at hand also has the advantage that a collection of human values in and at the hard hat and its transmission to a retrieving unit can also take place during periods of training. As a result, the players can be monitored regarding their physiological data in an uninterrupted fashion, providing a training profile or profile for the individual player.

For reasons of simplicity, the subsequently described embodiment shows how skin temperature of the hard hat user is measured by means of a temperature sensor. Preferably, the temperature sensor is designed as thermal resistor with its measuring window directed toward the forehead of the hard hat user. In addition to measurements touching the skin, the invention also provides for measurements recording merely heat radiation of the skin.

Thus, merely the skin temperature on the forehead is measured, which possibly is subject to certain incorrect measurements. On the one hand, because of evaporative heat loss, the forehead significantly cools down and therefore does not reflect the correct body temperature. On the other hand, the temperature of the forehead does not represent the physiological condition of the hard hat user.

Therefore, another embodiment of the invention at hand preferably measures the core temperature of the hard hat user. This involves several possibilities.

A first embodiment provides to measure by means of an infrared diode the proximity of the auditory canal of the human ear. Preferably, the infrared diode aims at the auditory canal to record the temperature of the internal ear.

Another embodiment of the invention arranges to position such a temperature sensor in the area of the nostrils, if possible even reaching into the nostrils, in order to measure the temperature inside the nose, which also correlates with human core temperature.

A third embodiment provides to record the temperature at other places of the human body, for example, in the area of the scalp or at other areas. It is also possible to position several temperature sensors, combining the various values and transmit the combined values to the retrieving unit.

In addition to measuring the core temperature of the hard hat user, there are several other measuring arrangements which are also included in the invention at hand. In this context, it has been arranged to measure skin moisture. Preferably, skin moisture is measured by means of resistance measurement at the scalp or another part of skin in the hard hat area, in order to record perspiration of the hard hat user.

A fourth embodiment provides to measure the pulse, arranging particularly for an ultra sound pulse measurement.

For example, by means of a respective ultra sound sensor, it is possible to read the aorta at the temples, allowing for measuring the pulse in this area.

Also the skin temperature in the area of this aorta can be recorded, allowing for the possibility to determine the temperature of the blood flowing through this area.

A further embodiment provides to connect a shock sensor to the head in order to record respective shock effects on the head. Such shock effects can be life threatening (as is known, for example, with boxers) and such shock effects can be perfectly recorded in the hard hat by connecting a specific shock sensor to the head in order to record such effects on the head.

Another application area for such shock sensors would be their usefulness to outsiders who could observe acoustically and optically the shock effects a player has to deal with during a game.

Another embodiment of the invention at hand even provides for the possibility of using intervening measuring methods, as, for example, performing blood analysis. In this case, it would be required to open a respective vein in the area of the head. It would also be possible to perform a chemical analysis of the perspiration which would open the way to evaluate several human parameters.

With all measuring arrangements it is important to perform the transmission by means of RFID transmitting technology. This means that a somewhat rod-like or band-like antenna of, for example, 60 mm in length is positioned inside the hard hat, in the upper are of the hard hat, provided the antenna transmits in a frequency range of 900 MHz.

Said antenna is connected to the transponder, which preferably is located in the upper and frontal area of the hard hat.

Preferably, the transponder is mounted in the space between the outer shell of the hard hat and the padding because there it will be relatively protected. The transponder is being supplied by a button cell-shaped battery and can be, for example, 50 mm in length and 25 mm in width.

The transponder has one or several connections for the sensors, whereas the following embodiment shows merely one connection for the temperature sensor. However, as already mentioned, the invention is not restricted to this embodiment.

As described at the beginning, arranging the transmitting antenna in the upper part of the hard hat guarantees that the dispersing transmission wave is not blocked or disrupted by the hard hat itself and that the waves can be transmitted to the retrieving unit positioned outside of the hard hat and in the radio field of the hard hat.

For this purpose, the transmitting antenna can be arranged in the interior space of the hard hat or on the outer side of the hard hat.

The invention at hand can also be developed to the extent that the antenna is not only transmitting but also receiving.

For example, such reception is required in order to transmit data signals from the retrieving unit, which is located on the outside, to the transponder. To this end, the retrieving unit located on the outside is able to transmit data signals to the hard hat requesting that the transponder and data memory located inside the hard hat should transmit their stored data.

The data signal can also indicate that only one hard hat should transmit its data whereas all other hard hats receiving the signal do not respond.

Such data signals can include also acoustical information heard by the hard hat user.

The subject matter of the invention at hand does not only involve the subject matter of the individual claims, but can also involve a combination of the various claims.

All statements and characteristics disclosed in the documents, including the abstract, but especially the space-related design depicted in the drawings are claimed to be a substantial part of the invention, to the extent that individually or in combination they are new compared to prior art.

Subsequently, the invention is explained in further detail by means of drawings which represent several models. The drawings and their descriptions disclose further characteristics and advantages significant for the invention.

It is shown:

FIG. 1: Schematic top view on a field including several players equipped with hard hats moving on the field.

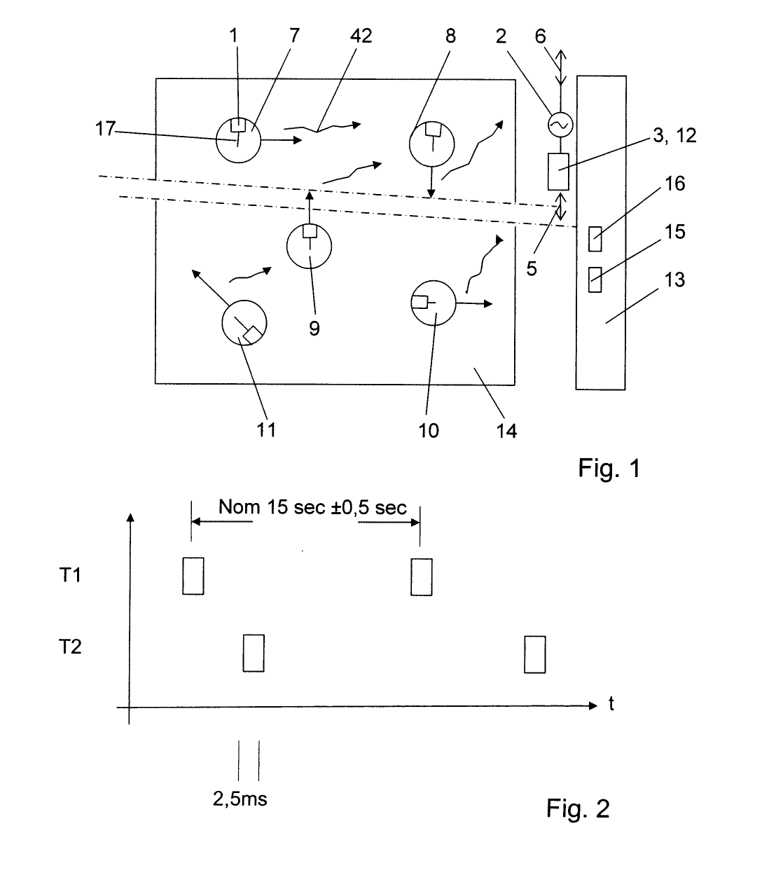

FIG. 2: Timing diagram regarding the programs of different transponders

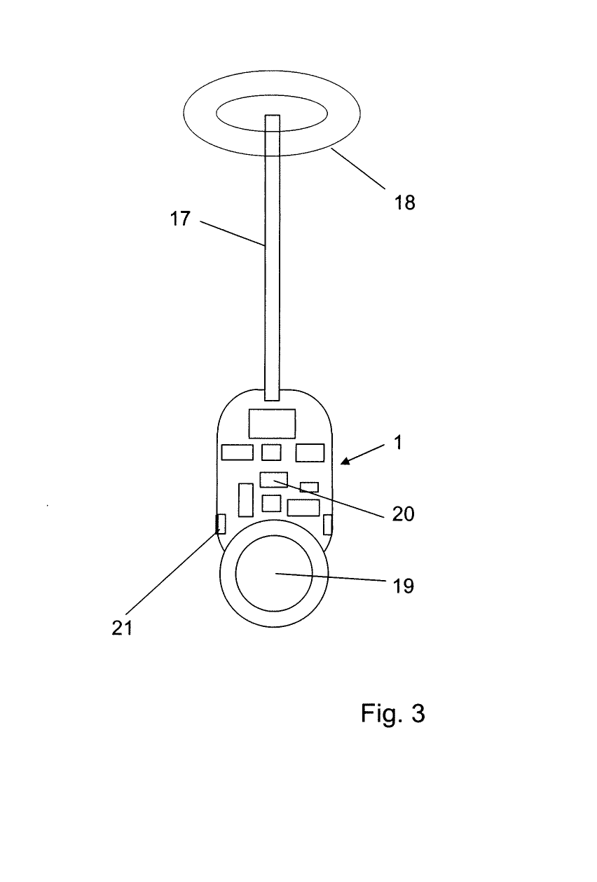

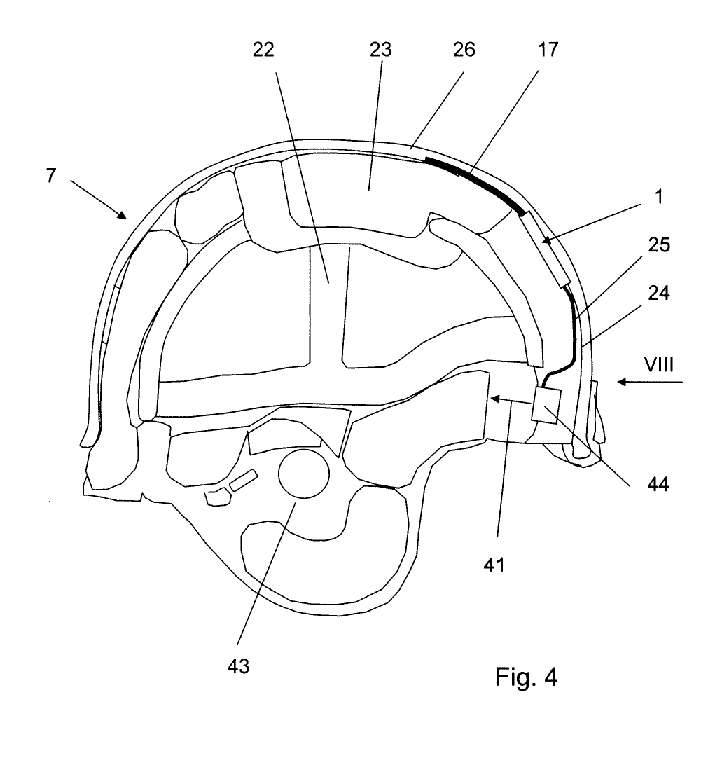

FIG. 3: Top view on a transponder

FIG. 4: Cross section through a hard hat according to the invention

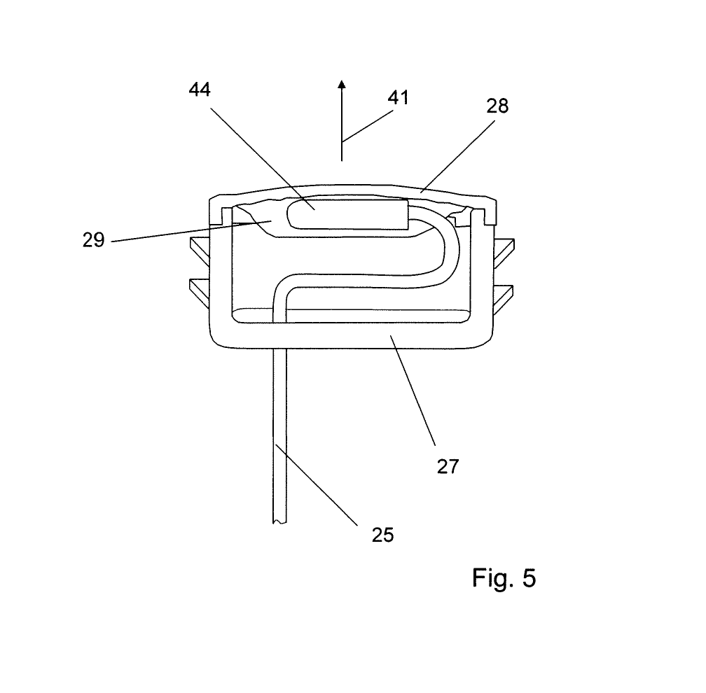

FIG. 5: Cross section through the housing for the temperature sensor

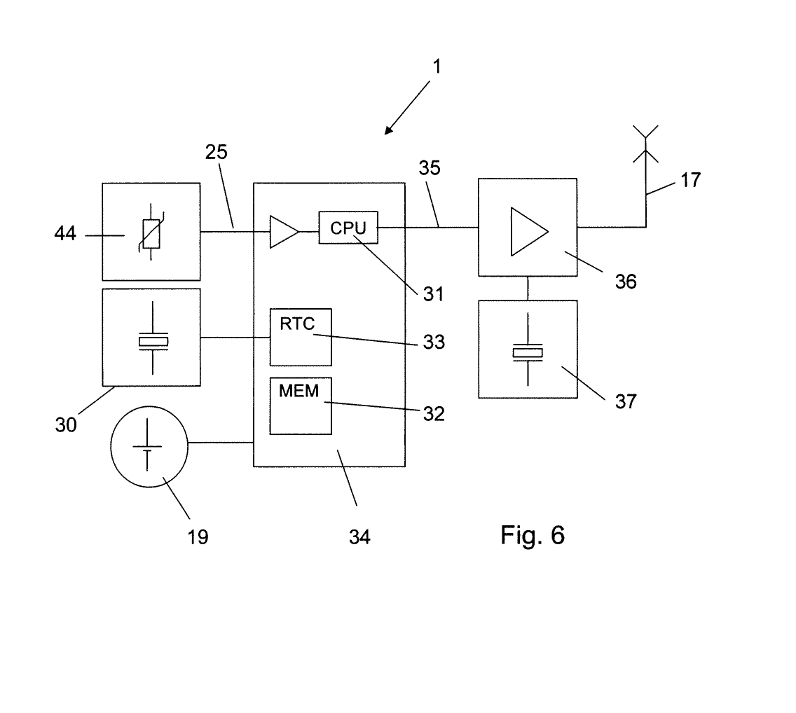

FIG. 6: Block diagram of a transponder

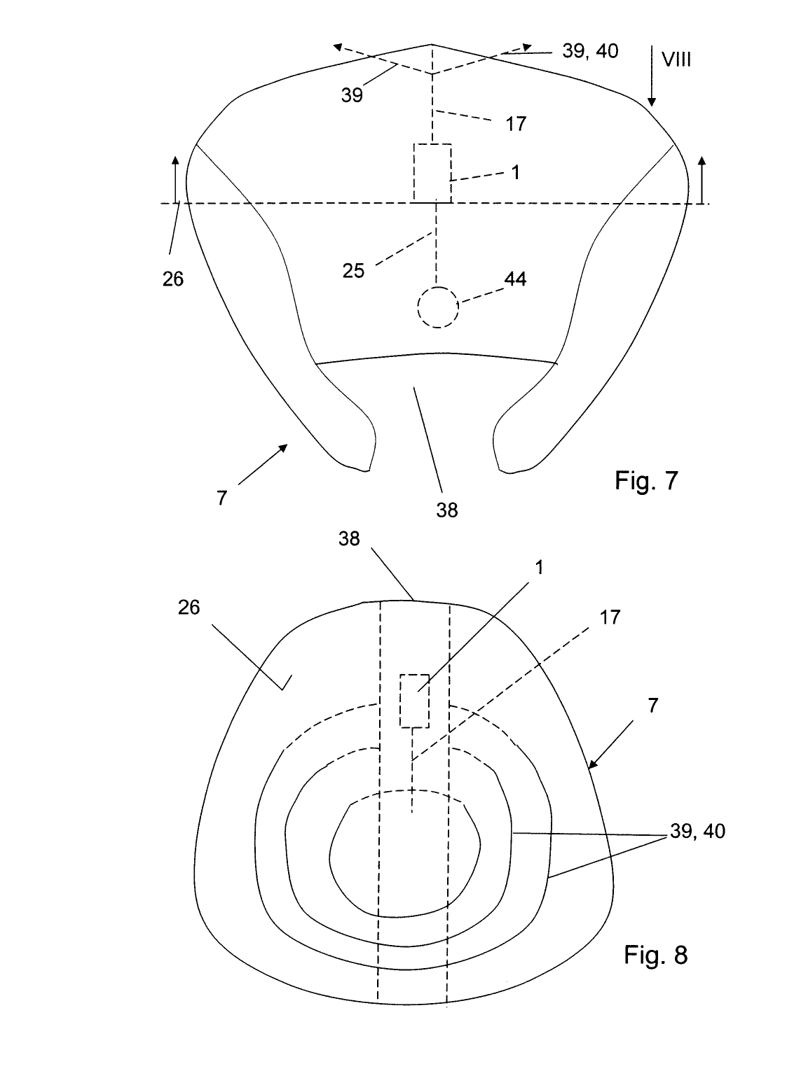

FIG. 7: Frontal view of a hard hat according to the invention

FIG. 8: Top view in the direction of the arrow VIII in FIG. 7.

FIG. 1 shows a field 14 on which several players are moving, whereas the players are moving randomly over the field 14 in the directions indicated by the arrow. The field extends over the entire length of the drawing according to FIG. 1, providing a total field length, for example, of between 100 m and 150 m and a width of 50 m.

Each player wears a specific hard hat 7-11, whereas the hard hats 7-11 are designed identical, so that subsequently only one hard hat has to be described in more detail.

Each hard hat has a transponder 1 in its frontal area and the antenna 17 connected to the transponder 1 is positioned in the upper part of the hard hat 26. In this way, each hard hat can transmit signals from the field 14 in the depicted directions of the arrow, producing omnidirectional propagation (see propagation direction 40). For example, a coach bench 13 is located at the edge of the field. Several people are seated on the bench, with one person having a manual scanner 15 and another person having a GSM terminal 16.

The radio waves of the transponder 1 are received by a retrieving unit 2, by means of its antenna 6. In one embodiment, said antenna is designed not only as receiving antenna but also as transmitting and receiving antenna.

The retrieving unit 2 can be connected to a module which can be designed, for example, as GSM module 3, in order to transmit data of the retrieving unit 2 to the GSM network and from there to the GSM terminal 16.

In addition, the GSM module 3 can also have an Internet interface 12, transmitting the data collected by the retrieving unit 2 via the Internet and associated Internet interface 12 directly to the manual scanner.

For example, PDA is one of these scanners.

The data can also be transmitted to a GSM terminal 16.

In this context, the GSM module 3 transmits to the GSM radio network by means of a transmitting and receiving antenna 5.

FIG. 2 shows that the different transponders 1 are able to transmit in various time slots. For example, on the ordinate, two transponders 1 are drawn, whereas one of them is depicted as transponder T1 and the other one as transponder T2. It is noticeable that each transponder transmits its data packet to the retrieving unit 2 at a distance of 15 s±0.5 s. It is also noticeable that the transmission of transponder 1 occurs time-delayed with regard to the transmission of transponder 2 and each data packet has a width of 2.5 ms.

In this way it is possible that quite a number of transponders 1 located in the hard hats 7-11 can transmit time-delayed data packets to each other, requiring, of course, that each data packet is equipped with an ID number so as to be able to assign at the retrieving unit 2 the transmitted data to the respective hard hat.

The data packets are transmitted as frequency modulated signals, which means that transmission is considerably less interference-prone than comparable AM modulated transmission.

In this context it is important that for a specific transmitting signal transmitted by the retrieving unit 2 a memory can be activated in the associated hard hat 7-11, which then selects the stored data and transmits it to the radio interface at the retrieving unit 2.

FIG. 3 shows an exemplified structure of a transponder 1 having a battery 19 and several components 20 in a housing, for example, of 50 mm length and 25 mm width. At the side, an interface 21 to connect a temperature sensor 44 has been provided. It is important that the antenna 17 has, for example, a length of 60 mm and is designed in the form of a flexible band so as to be able to relocate the band easily on the inside of the hard-hat 7. Therefore, the antenna transmits omnidirectional wave propagation 18 which extends spherically in all directions.

That is to say, if said antenna 17 is arranged in the upper part of the hard hat 26, the upper part of the hard hat generates a spherical wave extending horizontally together with the wave propagation 28 so that the hard hat itself (independent of inclination and angle toward the ground) does not present a disruption factor for the wave propagation 18.

FIG. 4 shows that the temperature sensor 44 is designed as a thermistor which is preferably directed in direction of the arrow 41 (measuring direction) toward the forehead of the hard hat user. In this way it is easy to record the skin temperature at the forehead. The temperature sensor 44 is connected to the transponder 1 via a connection cable 25. In this regard, it is important that the entire transponder unit 1 is positioned between the outer shell 24 and the padding 23 as well as the inside shell 22. In this way, the entire measuring device is relatively protected against impacts and other damages. It also can be exchanged easily.

The picture does not show that a thermistor or IR diode has been placed in the opening area of the ear, directed toward the auditory canal, in order to be able to measure the core temperature 44 of the hard hat user with considerably more precision than, by way of comparison, would be possible by means of the temperature sensor 44 directed in measuring direction 41 toward the forehead of the hard hat user.

FIG. 4 also does not show that, because of a resistance measurement between two measuring pads that are electrically conductible connected to the skin of the hard hat user, an additional temperature measurement can take place in the area of the upper part of the hard hat 26. By means of this resistance measurement of the skin conclusions can be drawn with regard to skin moisture.

It is also not shown that a pulse monitor is arranged at the lateral temple area, which consists mainly of an ultra sound sensor recording artery pulsation on the forehead, converting the measurement reading and preparing it for transmission.

FIG. 5 shows a detail of the temperature sensor 44 showing that it has been placed in a plastic housing 27. The front side of said housing is covered by a sensor membrane 28 and a casing 29 consisting of thermically conductible material is located at its rear side. Imbedded in said casing is the temperature sensor 44 which is designed as thermistor casing 29. In this way, the temperature sensor 44 is connected in a heat-conductible manner to the casing 29 which, in turn, is connected in a heat-conductible manner to the sensor membrane 28.

FIG. 6 shows a block diagram of a transponder 1 according to the invention, showing that a CPU 31 suitable to prepare and record measurement values is arranged in a control unit 34 which is designed as housing of the transponder 1. In the same housing of the transponder 1, a pulse generator 33 has been arranged as well as a memory 32 for potential storage of the recorded measuring values. The entire pulse is produced by an oscillator 30. The diagram shows that the temperature sensor 44 is designed as a resistor that can be modified.

Via the cable 35, the processed values recorded by the CPU 31 are supplied to a high frequency output, which, in the embodiment shown, consists of transmit-receive unit 36 which, in turn, controls the pulse generator 37.

The cable is shown only figuratively. In reality the HF transmit-receive unit 36 is located on the same circuit board than, for example, the CPU 31, the pulse generator and the memory 32.

At the output of the transmit-receive unit 36 the antenna 17 is located, which according to the preceding description, can be designed as a transmitting antenna or as a transmit-receive antenna.

FIGS. 7 and 8 show a diagram of the arrangement and assembly area of the transponder 1. FIG. 7 shows that the hard hat has in its frontal area an opening 38 for the face of the hard hat user and that the temperature sensor 44, which is preferably designed as disk and which is directed in measuring direction 41 toward the forehead of the hard hat user, is located in the area of the forehead. It is also shown that at lest the antenna 17 is located in the upper part of the hart hat 26 (see the upward pointing arrows at 26), so that, for example, wave propagation 40 takes place in the area of the crown of the head (i.e., in the upper part of the hard hat). This is also shown in FIG. 8, which shows a top view on the hard hat in the direction of the arrow VIII according to FIG. 7. There it is shown that the antenna 17 is a flexible band which extends up to the top part of the hard hat. Therefore omnidirectional propagation takes place in all directions of the arrow 39 in the entire upper pole area of the hard hat. As a result, independent of the inclination of the hard hat and the size of the hard hat user, unrestricted wave propagation is guaranteed over the entire field in the direction of the retrieving unit 2.

Instead of a flexible band, it is also possible to use an antenna consisting of ceramic material.

### DIAGRAM LEGEND

1. Transponder (data carrier)
2. Retrieving unit
3. GSM module
4. Not occupied
5. Transmitting antenna (GSM)
6. Antenna (retrieving unit 2)
7. Hard hat
8. Hard hat
9. Hard hat
10. Hard hat
11. Hard hat
12. Internal interface
13. Coach bench
14. Field
15. Manual scanner
16. GSM terminal user
17. Antenna (hard hat)
18. Wave propagation
19. Battery
20. Components
21. Interface
22. Inside shell
23. Padding
24. Outer shell
25. Connection cable
26. Upper part of the hard hat
27. Housing
28. Sensor membrane
29. Casing
30. Oscillator
31. CPU
32. Memory
33. Pulse generator
34. Control unit
35. Cable
36. Transmit-receive unit
37. Pulse generator
38. Opening for the face of the hard hat
39. Direction of arrow
40. Propagation direction
41. Measuring direction
42. Directions of arrow
43. Opening of the ear
44. Temperature sensor

1. Hard hat having wireless protection to monitor human measuring values, such as, temperature, pulse, moisture and other values which are recorded in the head section of a human and transmitted wirelessly to a stationary or mobile reception unit and which monitor the physical constitution of the hard hat user, characterized by the fact that the hard hat is equipped with a transponder which, in turn, is data connected to several measuring sensors, which are arranged inside and at the hard hat, and that the transponder is also connected to an antenna located in the upper part of the hard hat, which transmits as wireless radio wave in a specific frequency range the transmitting frequency transmitted by the transponder to a mobile or stationary transmit-receive unit arranged outside the field.

2. Hard hat according to claim 1, characterized by the fact that the antenna is designed as a circular transmitter and transmits an omnidirectional radio wave.

3. Hard hat according to claim 1, characterized by the fact that the antenna is designed as directional transmitter transmitting a radiated beam to the transmit-receive unit, at which the radiated beam transmits forward and backward at a range of between 60 and 120 degrees, allowing to determine the hard hat users direction of movement.

4. Hard hat according to one claim 1, characterized by the fact that the antenna transmits the transmitting frequency transmitted by the transponder over a field length of 100 m and a field width of 50 m to a mobile or stationary transmit-receive unit.

5. Hard hat according to claim 1, characterized by the fact that the frontal part of the player's hard hat, preferably the upper part of the hard hat includes the transponder together with the antenna, at which the hard hat produces an omnidirectional propagation direction from the field to a manual scanner and/or GSM terminal.

6. Hard hat according to claim 1, characterized by the fact that a retrieving unit received the radio waves transmitted by the transponder by means of an antenna arranged at the retrieving unit, at which the antenna is designed as transmit antenna or transmit-receive antenna.

7. Hard hat according to claim 1, characterized by the fact that the retrieving unit is connected to a module which is designed as GSM module and transmits the data of the retrieving unit to a GSM network and subsequently to a GSM terminal.

8. Hard hat according to claim 1, characterized by the fact that the GSM module also has an Internet interface which transmits the data collected by the retrieving unit via the Internet by means of an Internet interface directly to the manual scanner, for example, a PDA and/or the GSM terminal.

9. Hard hat according to claim 1, characterized by the fact that the transmission of the GSM module to the GSM radio network takes place by means of a transmit-receive antenna.

10. Hard hat according to claim 1, characterized by the fact that several transponders transmit to the retrieving unit the respective data packet to various time slots of approximately 15 s±0.5 s, at which each data packet has a width of 2.5 ms.

11. Hard hat according to claim 1, characterized by the fact that the data packets transmitted each have an ID number which assign at the retrieving unit (2) the transmitted data packets to the respective hard hat.

12. Hard hat according to claim 1, characterized by the fact that the data packets are transmitted as frequency modulated signals, guaranteeing disruption-unsusceptible transmission.

13. Hard hat according to claim 1, characterized by the fact that the retrieving unit transmits a specific transmitting signal which activates the respective hard hat, reads the stored data and transmits this data to the retrieving unit via a radio interface.

14. Hard hat according to claim 1, characterized by the fact that the transponder is located in a housing together with a battery and other components, having an interface at the side of the housing to connect the temperature sensor.

15. Hard hat according to claim 1, characterized by the fact that the antenna arranged at or in the hard hat is designed as a band having a length of 60 mm and spherical wave propagation extending to all directions.

16. Hard hat according to claim 1, characterized by the fact that the antenna located in the upper part of the hard hat forms a horizontally extending spherical wave having wave propagation, whereby the hard hat prevents disruption of the wave propagation regardless of the inclination of the hard hat and its angle to the ground.

17. Hard hat according to claim 1, characterized by the fact that the temperature sensor is designed as a thermistor which, preferably, in direction of the arrow, is directed toward the forehead of a hard hat user and records the skin temperature at the forehead of the hard hat user.

18. Hard hat according to claim 1, characterized by the fact that the temperature sensor is connected to the transponder via a connection cable, at which the entire transponder unit is positioned between the outer shell and the padding as well as the inside shell of the hard hat, protecting the measuring device against impacts and other damages and allows for easy exchange of the temperature sensor.

19. Hard hat according to claim 1, characterized by the fact that a thermistor or IR diode arranged in the opening area of the ear makes it possible to measure the core temperature of the hard hat user with considerably more precision than would be possible by means of the temperature sensor directed in measuring direction toward the forehead of the hard hat user.

20. Hard hat according to claim 1, characterized by the fact that, in the upper part of the hard hat, two measuring pads are located which perform the measurement of the skin temperature by means of resistance measurement between the measuring pads, at which the measuring pads are attached to the skin of the hard hat user and the recorded measuring value indicates a moisture value of the skin of the hard hat user.

21. Hard hat according to claim 1, characterized by the fact that the hard hat, at the lateral temple area, has an ultra sound sensor which basically records pulse measurements which are converted and transmitted in the transponder.

22. Hard hat according to claim 1, characterized by the fact that the temperature sensor is located in a plastic housing, the front side of which is covered by a sensor membrane and which has a casing at its rear side consisting of thermically conductible material, in which the temperature sensor designed as thermistor casing is imbedded and connected in a heat-conductible manner to the casing which, in turn, is connected in a heat-conductible manner to the sensor membrane.

23. Hard hat according to claim 1, characterized by the fact that the antenna is designed as transmitting antenna or as a transmit-receive antenna.

24. Procedure for wireless protection to monitor human measuring values, such as, temperature, pulse, moisture, shock effects and other values which are recorded in the head section of a human and transmitted wirelessly to a stationary or mobile reception unit and which monitor the physical constitution of the hard hat user, characterized by the fact that a hard hat having several measuring sensors is data connected to at least one transponder located in or at the hard hat, at which the transponder forms a connection with an antenna located in the upper part of the hard hat, which transmits as radio wave in a specific frequency range the transmitting frequency transmitted by the transponder to a mobile or stationary transmit-receive unit arranged outside the field.

25. (canceled)

26. Hard hat to be used on the head of a person according to claim 1, characterized by the fact that it is suitable to perform wireless transmission of physiological values of the hard hat user, for example, skin temperature, skin moisture, pulsation.

27. Hard hat to be used on the head of a person according to claim 1, characterized by the fact that it is suitable for wireless transmission of physical values, for example, shock effects on the hard hat.
